(19) United States
(12) Patent Application Publication
(10) Pub. No.: US 2026/0073595 A1
(43) Pub. Date: Mar. 12, 2026

(54) MEDIA GENERATION METHOD, APPARATUS, DEVICE AND STORAGE MEDIUM

(71) Applicant: Beijing Zitiao Network Technology Co., Ltd., Beijing (CN)

(72) Inventors: Zhenan Li, Beijing (CN); Weiwei Yu, Beijing (CN); Yi Duan, Beijing (CN); Weijian Chen, Beijing (CN); Peijun Guo, Beijing (CN); Yurou Xia, Beijing (CN); Qing Chen, Beijing (CN)

(21) Appl. No.: 19/327,015

(22) Filed: Sep. 12, 2025

(30) Foreign Application Priority Data
Sep. 12, 2024 (WO) PCT/CN2024/118623

(51) Int. Cl. G06T 11/60; G06F 16/538

(52) U.S. Cl. CPC G06T 11/60; G06F 16/538; G06T 2200/24

(57) ABSTRACT

The embodiment of the disclosure relates to a media generation method, apparatus, device and storage medium. The method provided herein includes: receiving a media generation request of a user; in response to the media generation request, determining a first media content from a media library associated with the user; and presenting a second media content generated based at least on the first media content, the second media content including a first portion and a second portion, the first portion corresponding to picture content of the first media content, and the second portion indicating reference information associated with the first media content.

### CROSS-REFERENCE

The present application claims priority to PCT Application No. PCT/CN2024/118623, filed on Sep. 12, 2024 and entitled “MEDIA GENERATION METHOD, APPARATUS, DEVICE AND STORAGE MEDIUM”, the entirety of which is incorporated herein by reference.

### FIELD

Example embodiments of the present disclosure generally relate to the field of computers, and in particular, to a media generation method, an apparatus, a device, and a computer-readable storage medium.

### BACKGROUND

Media content generation occupies a higher position in the information propagation and entertainment industry, and is widely applied to the fields of advertisements, movies, games, videos, news and the like. The media content generation technology can also help users creating higher quality content, for example, to share.

### SUMMARY

In a first aspect of the present disclosure, a media generation method is provided, comprising: receiving a media generation request of a user; in response to the media generation request, determining a first media content from a media library associated with the user; and presenting a second media content generated based at least on the first media content, the second media content comprising a first portion and a second portion, the first portion corresponding to picture content of the first media content, and the second portion indicating reference information associated with the first media content.

In a second aspect of the present disclosure, an apparatus for media generation is provided. The apparatus comprises: a receiving module, configured to receive a media generation request of a user; a determining module, configured to determine, in response to the media generation request, first media content from a media library associated to the user; and a presenting module, configured to present a second media content generated based on at least the first media content, the second media content comprising a first portion and a second portion, the first portion corresponding to picture content of the first media content, and the second portion indicating reference information associated to the first media content.

In a third aspect of the present disclosure, a display device is provided. The device comprises at least one processing unit; and at least one memory coupled to the at least one processing unit and storing instructions for execution by the at least one processing unit, the instructions, when executed by the at least one processing unit, cause the device to perform the method of the first aspect.

In a fourth aspect of the present disclosure, a computer-readable storage medium is provided. The computer-readable storage medium stores a computer program thereon, and the computer program is executable by the processor to perform the method of the first aspect.

It should be understood that the summary described in this disclosure is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in combination with the accompanying drawings. In the drawings, the same or similar reference numbers refer to the same or similar elements, wherein:

FIG. 1 illustrates a schematic diagram of an example environment in which some embodiments of the present disclosure can be implemented;

FIGS. 2A-2F illustrate example interfaces for media generation according to some embodiments of the present disclosure;

FIG. 3 illustrates a flowchart of an example process of media generation according to some embodiments of the present disclosure;

FIG. 4 illustrates a schematic structure block diagram of an example apparatus for media generation according to some embodiments of the present disclosure; and

FIG. 5 illustrates a block diagram of a device capable of implementing various embodiments of the present disclosure.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first,” “second,” and the like may refer to different or same objects. Other explicit and implicit definitions may also be included below.

The embodiments of the present disclosure may relate to user data, acquisition and/or use of data, and the like. These aspects shall comply with the requirements of corresponding laws, regulations and relevant provisions. In the embodiments of the present disclosure, the collection, acquisition, processing, manufacturing, forwarding, use of all data and the like are carried out with user's knowledge and consent. Accordingly, in the implementation of the embodiments of the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract, etc.) and will be performed only within a specified or agreed scope. If users decline the processing of personal information beyond what is essential for basic functionalities, their utilization of these basic features remains uninterrupted.

As briefly mentioned above, media content generation occupies a higher position in the information propagation and entertainment industry and is widely applied in the fields of advertisements, movies, games, videos, news and the like. Among them, the image generation technology has become the key strength of pushing the media content innovation by means of advantages of efficient generation and widely application.

The embodiments of the present disclosure provide a solution for media generation. According to the solution, a media generation request of a user may be received; in response to the media generation request, a first media content is determined from a media library associated with the user; and a second media content generated based at least on the first media content is presented, the second media content comprises a first portion and a second portion, the first portion corresponds to picture content of the first media content, and the second portion indicate reference information associated with the first media content.

In this way, the embodiments of the present disclosure can select existing media content from the media library and perform a predetermined media processing to generate new media content. Therefore, the embodiments of the present disclosure can help the user to review the predetermined media content in the media library and improve the efficiency of the user's knowing of the media content related information. In addition, the embodiments of the present disclosure can reduce interaction cost of the user and improve the efficiency of the media generation.

Various example implementations of this solution are described in detail below in combination with the accompanying drawings.

### Example Environment

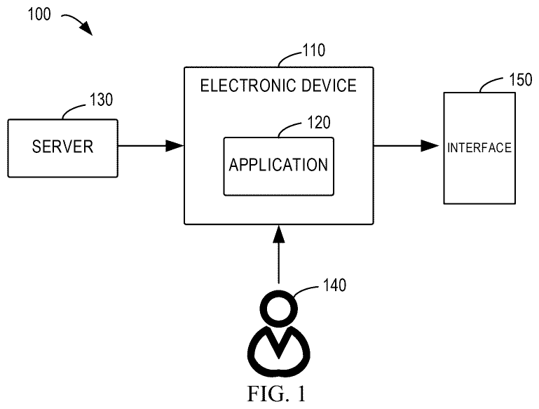

FIG. 1 illustrates a schematic diagram of an example environment 100 in which embodiments of the present disclosure can be implemented. As shown in FIG. 1, the example environment 100 may include an electronic device 110.

In the environment 100 of FIG. 1, the electronic device 110 may run an application 120 that supports media generation. The application 120 may be any suitable type of application that requires media generation, examples of which may include, but are not limited to: a video application, a social application, or other suitable application. An user may interact with the application 120 via a controller 140 connected in communication with a display device 110.

In the environment 100 of FIG. 1, if the application 120 is active, the display device 110 may present, via the application 120, an interface 150 for supporting media generation. The interface 150 may include various pages provided by the application 120, such as a generation page of media content.

In some embodiments, the electronic device 110 communicates with a server 130 to carry out provision of service to the application 120. The server 130 may provide functions such as management, configuration, maintenance, and media generation on applications or websites.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination thereof, including accessories and peripherals of these devices or any combination thereof. In some embodiments, the electronic device 110 can also support any type of interface for a user (such as a “wearable” circuit, etc.).

The server 130 may be a standalone physical server, a server cluster or a distributed system composed of multiple physical servers, or may also be a cloud server that provides basic cloud computing services such as cloud services, cloud databases, cloud computing, cloud functions, cloud storage, network services, cloud communication, middleware services, domain name services, security services, content distribution networks, and big data and artificial intelligence platforms. The server 130 may include, for example, a computing system/server, such as a mainframe, an edge computing node, a computing device in cloud environments, or the like. The server 130 may provide background services for the application 120 that support virtual scenes in the electronic device 110.

A communication connection may be established between the server 130 and the electronic device 110. The communication connection may be established via wired or wireless manners. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In the embodiments of the present disclosure, the server 130 and the electronic device 110 may implement signaling interaction through the communication connection between the server 130 and the electronic device 110.

It should be understood that the structures and functions of the various elements in the environment 100 are described solely for example purposes and do not imply any limitation on the scope of the present disclosure.

Various example implementations of the present disclosure will be described in detail below.

### Example Interaction

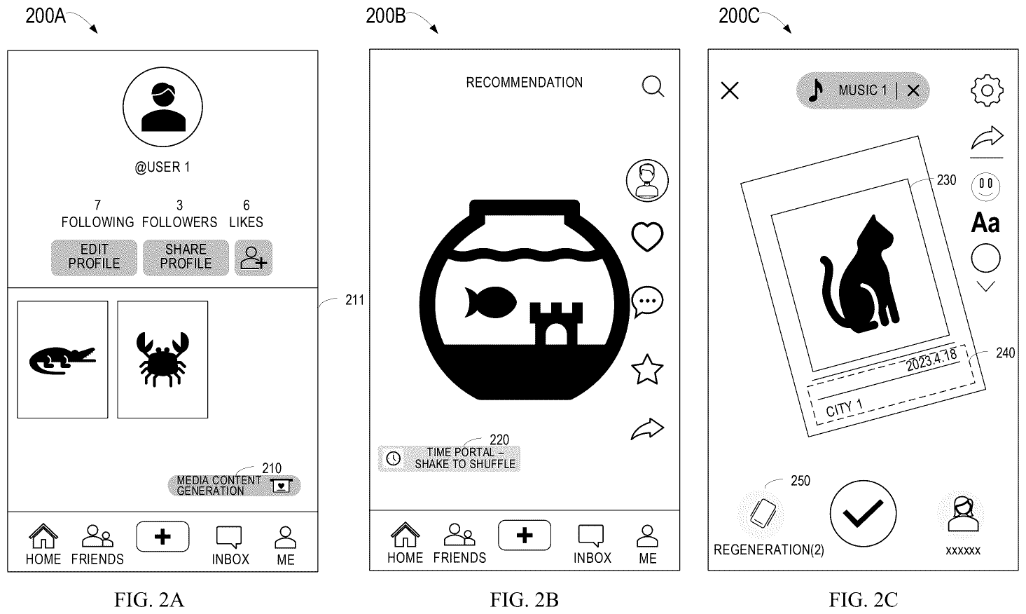

FIGS. 2A-2F illustrate example interfaces 200A-200F according to some embodiments of the present disclosure. The interfaces 200A-200F may be provided, for example, by an electronic device 110 shown in FIG. 1. Examples 200A-200F are described below with reference to FIG. 1.

In some embodiments, the electronic device 110 may present a profile page of a user. Further, the electronic device 110 may obtain a media generation request of the user based on a selection of a generation entry in the profile page.

In some scenarios, as shown in FIG. 2A, an interface 200A for example may present the profile page of the user, and the profile page includes at least a user identifier of the user, a posted media content set 211, and a media content generation control 210. The electronic device 110 may trigger a reception event of the media generation request in response to a selection of the user for the media content generation control 210.

Alternatively, in some embodiments, the media content generation control 210 may be set anywhere within the interface 200A in a predetermined style. For example, the media content generation control 210 may be set in the form of a picture at a location within the interface 200A where the posted media content set 211 is located.

In some embodiments, the electronic device 110 receives the media generation request of the user. As an example, as shown in FIG. 2A, the electronic device 110 may receive the media generation request in response to the selection of the user 140 for the media content generation control 210 in the interface 200A.

In some embodiments, the electronic device 110 determines a first media content from a media library associated with the user in response to the media generation request. As an example, the media library may be, for example, a cloud photo album or a local photo album of the user. The album may include, for example, at least one picture content or video content. It should be understood that the media content and associated information in the media library is obtained and used with user's knowledge and authorization.

In some embodiments, the electronic device 110 may, for example, randomly determine one or more media content items from the media library as the first media content. Alternatively, the electronic device 110 may further determine, from the media library, one or more media content items that meet a predetermined condition. Such a predetermined condition may relate to time information, subject information, location information, and the like of the media content.

In some embodiments, the electronic device 110 may further determine the first media content based on input information of the user. Specifically, the electronic device 110 may, for example, obtain the input information of the user. Such input information may include any suitable type of information, such as text information, voice information, image information, video information, and the like.

Further, the electronic device 110 may determine, based on the input information, the first media content from the media library associated with the user.

As an example, the electronic device 110 may obtain a reference picture uploaded by the user 140 through an interface 150. Accordingly, the electronic device 110 may determine, based on the reference picture, the first media content from the media library associated with the user. For example, the first media content may be associated with the same topic as the reference picture, or similarity of the first media content to the reference picture may exceed a threshold.

In some embodiments, the input information of the user may further indicate at least one of time information, location information, character information, or topic information. As an example, the electronic device 110 may determine, from the media library, the first media content associated with time information, topic information, character information, or location information input by the user.

For example, the user may specify a certain historical time point. For example, the electronic device 110 may determine a photo or a video shot at the historical time point as the first media content. As another example, the user may for example specify a certain topic, such as “Christmas”. The electronic device 110 may for example determine the content related to “Christmas” as the first media content.

As another example, the user may for example specify a particular friend. The electronic device 110 may determine for example a photo or a video including the friend as the first media content. As a further example, the user may for example specify a certain location. The electronic device 110 may for example determine a photo or a video shot at the specific location as the first media content.

In this way, the embodiments of the present disclosure may perform, based on the media content matched with user demand, a generation process of the media content, thereby improving the quality of the generated media content and meeting the user's creation demand.

In some embodiments, the electronic device 110 may obtain a second media content generated based on the first media content. In some embodiments, the second media content may be generated based on the first media content by the electronic device 110 and/or a server 130.

As an example, as shown in FIG. 2C, the electronic device 110 may present, in a media content viewing interface 200C, the second media content generated based on the first media content.

As shown in FIG. 2C, the second media content may include a first portion 230 and a second portion 240. The first portion 230 may present picture content of the first media content. Taking the first media content being a photo as an example, the first portion 230 may be determined by appropriate processing (e.g., scaling, rotation, applying a filter) to this photo. In some embodiments, the first media content for example may be video content, and correspondingly, the first portion 230 may for example present picture content corresponding to the video content.

Additionally, the second portion 240 may present reference information associated with the first media content. In some embodiments, the reference information may be used to describe any suitable attribute of the first media content. As an example, the reference information may describe shooting time, shooting location, content topic, and the like of the first media content.

In some embodiments, the second media content may be generated based on a suitable media template. Such a media template may indicate an effect applied by the picture content of the first media content, a layout of the first portion and the second portion, an information type included in the second portion, a display style of the second portion, and the like.

In some embodiments, the media template used to generate the second media content may also be determined based on the first media content. That is, the second media content may be generated based on the media template matching the first media content.

As an example, the first media content may be a photo related to winter. Accordingly, the media template may indicate applying a filter related with the winter theme to the photo. Additionally, the display style of the reference information included in the second portion may also be associated with a winter theme, for example, the text may be filled with snowflake texture or the like.

In some embodiments, the generated second media content may include a single photo. Alternatively, the generated second media content may also be associated with a plurality of images. For example, the second media content may be video content associated with a plurality of video frames. Or the second media content may be picture set content including a plurality of photos.

Accordingly, at least one of the plurality of images (e.g., the plurality of video frames or the plurality of photos) associated with the second media content may include the first portion and the second portion as introduced above.

In some embodiments, such a plurality of images may also include one additional image generated based on at least one additional media content determined from the media library.

Taking the second media content including video content as an example, a first set of the video frames of the video content may be generated based on a first photo in the media library, and a second set of the video frames may be generated based on a second photo in the media library. In some embodiments, such a first and second photo may also have related attributes, e.g., associated with the same time, place, character, topic, etc.

As another example, taking the second media content including the picture set content as an example, a first image of the picture set content may be generated based on a certain photo in the media library, and a second image may be generated based on another photo in the media library. Similarly, the plurality of images used to generate the picture set content in the media library may have related attributes, e.g., associated with the same time, place, character, topic, etc.

In this manner, the embodiments of the present disclosure may automatically determine the plurality of related media content from the media library and automatically provide a corresponding aggregated media content for the user such as a video or a picture set.

In some embodiments, the electronic device 110 may receive a regeneration request for the second media content, and accordingly determine, from the media library, a third media content different from the first media content. Further, the electronic device 110 may present a fourth media content generated based on the third media content.

As an example, as shown in FIG. 2C, the interface 200C presents a viewing interface of the second media content. A regeneration control 250 may be included in the interface 200C. The electronic device 110 may regenerate the media content in response to a selection of the user 140 for the regeneration control 250 in the interface 200C.

In some scenarios, a regeneration task may be associated with a predetermined upper number of times. When the electronic device 110 detects the post of the media content, the execution times of the regeneration task may be reset.

In some embodiments, the electronic device 110 may further receive a predetermined somatosensory action to obtain the regeneration request. As an example, the electronic device 110 may, for example, obtain the somatosensory action of the user shaking a mobile phone to obtain the regeneration request. By triggering the regeneration request through the somatosensory action, the embodiments of the present disclosure may effectively improve the immersive sense of interaction between the user and a media generation application.

In some embodiments, the media generation request may further be triggered based on a predetermined operation received in the viewing interface of target media content. As an example, the electronic device 110 may present an interface 200B as shown in FIG. 2B. The interface 200B is a viewing interface of the target media content. In some embodiments, the viewing interface may be associated with a media content stream, and the user may implement switching between the plurality of media content in the media content stream based on a content switching operation, such as an up-down sliding operation.

As shown in FIG. 2B, the interface 200B may include a generation control 220 (also referred to as a function anchor), and the electronic device 110 may trigger the media generation request in response to a selection of user 140 for the generation control 220 to create new media content based on one or more media content items in the media library of the user.

In some embodiments, based on reference description information of the target media content, the electronic device 110 may determine the first media content associated with the reference description information from the media library associated with the user..

As an example, the electronic device 110 may obtain the reference description information of the target media content, and determine the first media content associated with the reference description information from the media library associated with the user. For example, as shown in FIG. 2B, the target media content may be a photo of a user A and a user B posted by the user B. Accordingly, the electronic device 110 may determine other photos of the user A and the user B from the media library associated with the user A as the first media content.

In this way, the embodiments of the present disclosure can determine, from the media library, other media content associated with the viewed media content to create the content related new media content accordingly.

In some embodiments, the browsed target media content may be generated based on reference media content in the media library of the user B. And the reference description information of the target media may indicate time information, location information, character information, topic information and the like of the reference media content.

For example, user B may trigger generating the target media content based on the reference media content through a generation entrance of the profile page. Correspondingly, when the user A initiates a generation request through the viewing interface of the target media content, association information (that is, the reference description information) of the reference media content may be used to determine the first media content in the media library of the user A to generate the corresponding second media content.

In some embodiments, the electronic device 110 may also present an animation indicating a process of determining the first media content from the media library. As an example, in the process of the media content generation, the electronic device 110 may present a predetermined animation effect in the viewing interface of the media content. The animation effect may be, for example, an animation effect as shown in FIGS. 2D-2F.

As an example, as shown in FIG. 2D, in the process of generating the second media content, the electronic device 110 may display, in an area 260 within a interface 200D, a switching animation of the plurality of media content items in the media library, to indicate a dynamic process of selecting the first media content from the media library.

Additionally, as shown in FIGS. 2E-2F, the electronic device 110 for example may also dynamically present the generated second media content in an area 270. For example, the electronic device 110 may enlarge a display range of the second media content to gradually display the generated second media content.

In this way, the embodiments of the present disclosure can select existing media content from the media library and perform a predetermined media processing to generate new media content. Therefore, the embodiments of the present disclosure can help the user to review the predetermined media content in the media library and improve the efficiency of the user's knowing of the media content related information. In addition, the embodiments of the present disclosure can reduce interaction cost of the user and improve the efficiency of the media generation.

### Example Processes

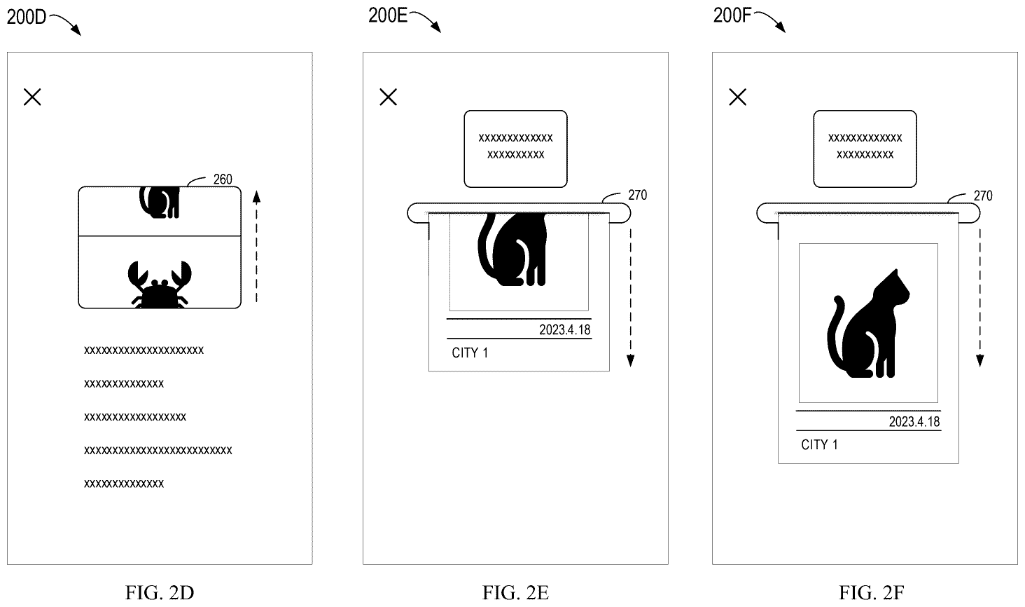

FIG. 3 illustrates a flowchart of an example process 300 of media content generation according to some embodiments of the present disclosure. Process 300 may be implemented at an electronic device 110. The process 300 is described below with reference to FIG. 1.

As shown, at block 310, the electronic device 110 receives a media generation request for a user.

At block 320, the electronic device 110 determines a first media content from a media library associated with the user in response to the media generation request.

At block 330, the electronic device 110 presents a second media content generated based at least on the first media content. The second media content includes a first portion and a second portion, the first portion corresponding to picture content of the first media content, and the second portion indicating reference information associated with the first media content.

In some embodiments, the process 300 further includes: presenting a profile page of the user; and obtaining the media generation request of the user based on a selection of a generation entry in the profile page.

In some embodiments, the process 300 further includes: presenting a viewing interface of target media content, the viewing interface displaying a generation control; in response to a selection of the generation control, obtaining the media generation request of the user.

In some embodiments, the second media content is further generated based on the target media content.

In some embodiments, determining the first media content from the media library associated with the user includes: based on reference description information of the target media content, determining the first media content associated with the reference description information from the media library associated with the user.

In some embodiments, the target media content is generated based on reference media content, and the reference description information indicate at least one of the following: time information, location information, character information, topic information of the reference media content.

In some embodiments, the process 300 further includes: presenting, in the viewing interface of the second media content, reference information associated to the target media content.

In some embodiments, the process 300 further includes: in response to a regeneration request for the second media content, determining, from the media library, a third media content different from the first media content; and presenting a fourth media content generated based on the third media content.

In some embodiments, the process 300 further includes: in response to receiving a predetermined somatosensory action, obtaining the regeneration request.

In some embodiments, determining the first media content from the media library associated with the user comprises: obtaining input information of the user; and determining, based on the input information, the first media content from the media library associated with the user.

In some embodiments, the input information indicates at least one of the following: time information, location information, character information, topic information.

In some embodiments, the second media content is generated based on a media template matching the first media content.

In some embodiments, the process 300 further includes: presenting an animation indicating a process of determining the first media content from the media library.

In some embodiments, the second media content is associated with a plurality of images, wherein at least one of the plurality of images comprises the first portion and the second portion.

In some embodiments, the plurality of images further comprise at least one additional image generated based on at least one additional media content determined from the media library.

### Example Apparatus and Apparatus

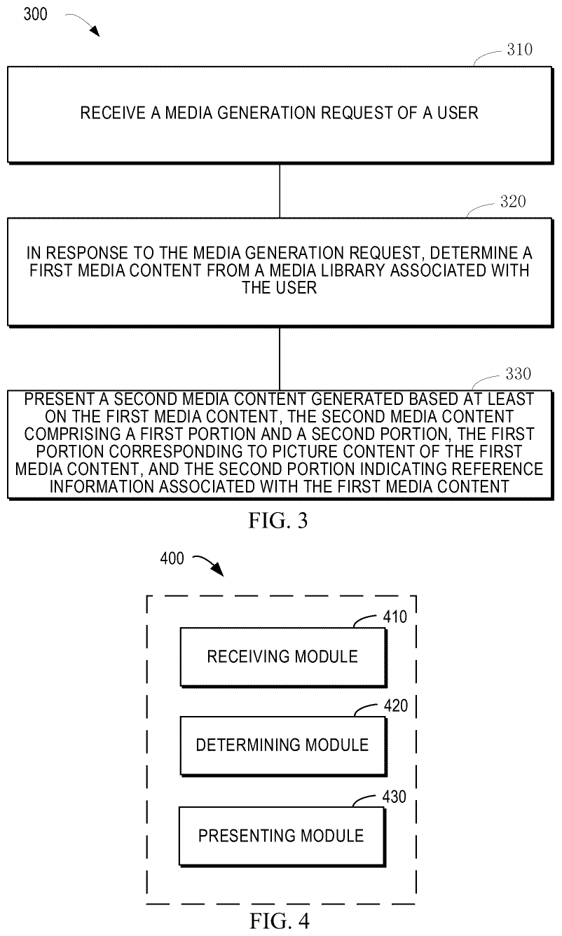

The embodiments of the present disclosure also provide a corresponding apparatus for performing the above method or process. FIG. 4 illustrates a schematic structure block diagram of an example apparatus 400 for media generation according to some embodiments of the present disclosure. The apparatus 400 may be implemented or included in an electronic device. The various modules/components in the apparatus 400 may be implemented by hardware, software, firmware, or any combination thereof.

As shown in FIG. 4, the apparatus 400 includes: a receiving module, configured to receive a media generation request of a user; a determining module, configured to determine, in response to the media generation request, first media content from a media library associated to the user; and a presenting module, configured to present a second media content generated based on at least the first media content, the second media content comprising a first portion and a second portion, the first portion corresponding to picture content of the first media content, and the second portion indicating reference information associated to the first media content.

In some embodiments, the apparatus 400 further includes a profile page presentation module configured to present a profile page of the user; and obtain the media generation request of the user based on a selection of a generation entry in the profile page.

In some embodiments, the apparatus 400 further includes a viewing interface presentation module configured to present a viewing interface of target media content, the viewing interface displaying a generation control; in response to a selection of the generation control, obtain the media generation request of the user.

In some embodiments, the second media content is further generated based on the target media content.

In some embodiments, the determining module 420 is further configured to based on reference description information of the target media content, determine the first media content associated with the reference description information from the media library associated with the user.

In some embodiments, the target media content is generated based on reference media content, and the reference description information indicate at least one of the following: time information, location information, character information, topic information of the reference media content.

In some embodiments, the viewing interface presentation module is further configured to present, in the viewing interface of the second media content, reference information associated to the target media content.

In some embodiments, the apparatus 400 further includes a regeneration module configured to: in response to a regeneration request for the second media content, determine, from the media library, a third media content different from the first media content; and present a fourth media content generated based on the third media content.

In some embodiments, the regeneration module is further configured to: in response to receiving a predetermined somatosensory action, obtain the regeneration request.

In some embodiments, the determining module 420 is further configured to: obtain input information of the user; and determine, based on the input information, the first media content from the media library associated with the user.

In some embodiments, the input information indicates at least one of the following: time information, location information, character information, topic information.

In some embodiments, the second media content is generated based on a media template matching the first media content.

In some embodiments, the apparatus 400 further includes an animation presentation module configured to present an animation indicating a process of determining the first media content from the media library.

In some embodiments, the second media content is associated with a plurality of images, wherein at least one of the plurality of images includes the first portion and the second portion.

In some embodiments, the plurality of images further includes at least one additional image generated based on at least one additional media content determined from the media library.

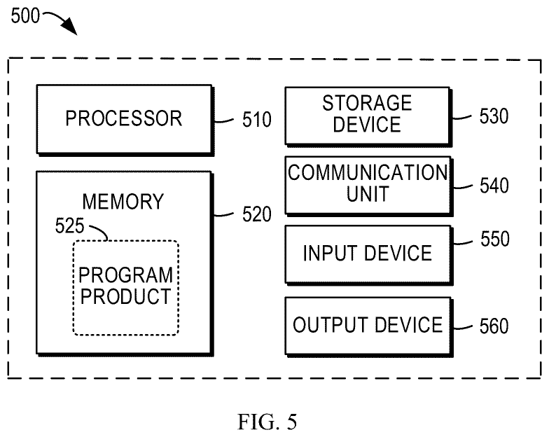

FIG. 5 illustrates a block diagram of a computing device 500 in which one or more embodiments of the present disclosure may be implemented. It would be appreciated that the computing device 500 illustrated in FIG. 5 is merely exemplary and should not constitute any limitation on the functionality and scope of the embodiments described herein. The computing device 500 shown in FIG. 5 may be used to implement the electronic device in FIG. 1.

As shown in FIG. 5, the computing device 500 is in the form of a general-purpose electronic device. Components of the computing device 500 may include, but are not limited to, one or more processors or processing units 510, a memory 520, a storage device 530, one or more communication units 540, one or more input devices 550, and one or more output devices 560. The processing unit 510 may be an actual or virtual processor capable of performing various processes according to a program stored in the memory 520. In a multiprocessor system, a plurality of processing units execute computer-executable instructions in parallel to improve the parallel processing capabilities of computing device 500.

The computing device 500 typically includes a variety of computer storage media. Such media may be any available media that are accessible to the computing device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium that can be used to store information and/or data and that can be accessed within the computing device 500.

The computing device 500 may further include an additional removable/non-removable, volatile/non-volatile storage medium. Although not shown in FIG. 5, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to execute various methods or actions of the various embodiments of the present disclosure.

The communication unit 540 is configured to communicate with other electronic devices through a communication medium. Additionally, the functionality of components of the computing device 500 may be implemented by a single computing cluster or multiple computing machines capable of communicating through a communication connection. Thus, the computing device 500 may operate in a networked environment using a logical connection with one or more other servers, network personal computers (PCs), or another network node.

The input device 550 may be one or more input devices such as a mouse, a keyboard, a trackball, a remote control, or the like. The output device 560 may be one or more output devices, such as a display, a projector, a television, or the like. The computing device 500 may also communicate with one or more external devices (not shown) through the communication unit 540 as needed. The external device, such as a storage device etc., communicates with one or more devices that enable users to interact with the computing device 500, or communicates with any device (e.g., a network card, a modem, etc.) that enables the computing device 500 to communicate with one or more other computing devices. Such communication may be performed via an input/output (I/O) interface (not shown).

According to example implementations of the present disclosure, a computer-readable storage medium having computer-executable instructions stored thereon is provided. The computer-executable instructions are executed by a processor to implement the method described above. According to example implementations of the present disclosure, a computer program product is further provided. The computer program product is tangibly stored on a non-transitory computer-readable medium and includes computer-executable instructions. The computer-executable instructions are executed by a processor to implement the method described above.

Various aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations of the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations of the present disclosure have been described above. The above description is exemplary, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

I/We claim:

1. A media generation method, comprising:
receiving a media generation request of a user;
in response to the media generation request, determining a first media content from a media library associated with the user; and
presenting a second media content generated based at least on the first media content, the second media content comprising a first portion and a second portion, the first portion corresponding to picture content of the first media content, and the second portion indicating reference information associated with the first media content.

2. The method of claim 1, further comprising:
presenting a profile page of the user; and
obtaining the media generation request of the user based on a selection of a generation entry in the profile page.

3. The method of claim 1, further comprising:
presenting a viewing interface of target media content, the viewing interface displaying a generation control; and
in response to a selection of the generation control, obtaining the media generation request of the user.

4. The method of claim 3, wherein the second media content is further generated based on the target media content.

5. The method of claim 3, wherein determining the first media content from the media library associated with the user comprises:
based on reference description information of the target media content, determining the first media content associated with the reference description information from the media library associated with the user.

6. The method of claim 5, wherein the target media content is generated based on reference media content, and the reference description information indicate at least one of the following: time information, location information, character information, topic information of the reference media content.

7. The method of claim 3, further comprising:
presenting, in the viewing interface of the second media content, reference information associated to the target media content.

8. The method of claim 1, further comprising:
in response to a regeneration request for the second media content, determining, from the media library, a third media content different from the first media content; and
presenting a fourth media content generated based on the third media content.

9. The method of claim 8, further comprising:
in response to receiving a predetermined somatosensory action, obtaining the regeneration request.

10. The method of claim 1, wherein determining the first media content from the media library associated with the user comprises:
obtaining input information of the user; and
determining, based on the input information, the first media content from the media library associated with the user.

11. The method of claim 10, wherein the input information indicates at least one of the following: time information, location information, character information, topic information.

12. The method of claim 1, wherein the second media content is generated based on a media template matching the first media content.

13. The method of claim 1, further comprising:
presenting an animation indicating a process of determining the first media content from the media library.

14. The method of claim 1, wherein the second media content is associated with a plurality of images, wherein at least one of the plurality of images comprises the first portion and the second portion.

15. The method of claim 14, wherein the plurality of images further comprise at least one additional image generated based on at least one additional media content determined from the media library.

16. An electronic device, comprising:
at least one processing unit; and
at least one memory coupled to the at least one processing unit and storing instructions for execution by the at least one processing unit, the instructions, when executed by the at least one processing unit, cause a display device to perform acts comprising:
receiving a media generation request of a user;
in response to the media generation request, determining a first media content from a media library associated with the user; and
presenting a second media content generated based at least on the first media content, the second media content comprising a first portion and a second portion, the first portion corresponding to picture content of the first media content, and the second portion indicating reference information associated with the first media content.

17. The device of claim 16, wherein the acts further comprise:
presenting a profile page of the user; and
obtaining the media generation request of the user based on a selection of a generation entry in the profile page.

18. The device of claim 16, wherein the acts further comprise:
presenting a viewing interface of target media content, the viewing interface displaying a generation control; and
in response to a selection of the generation control, obtaining the media generation request of the user.

19. The device of claim 16, wherein the acts further comprise:
in response to a regeneration request for the second media content, determining, from the media library, a third media content different from the first media content; and
presenting a fourth media content generated based on the third media content.

20. A non-transitory computer-readable storage medium having a computer program stored thereon, the computer program executable by a processor to perform a method comprising:
receiving a media generation request of a user;
in response to the media generation request, determining a first media content from a media library associated with the user; and
presenting a second media content generated based at least on the first media content, the second media content comprising a first portion and a second portion, the first portion corresponding to picture content of the first media content, and the second portion indicating reference information associated with the first media content.
